(19) United States
(12) Patent Application Publication
(10) Pub. No.: US 2004/0252329 A1
(43) Pub. Date: Dec. 16, 2004

(54) Method and system for monitoring status of printers from a SOHO network client

(76) Inventor: Dustin Sorenson, Austin, TX (US)

Correspondence Address: HAMILTON & TERRILE, LLP, P.O. BOX 203518, AUSTIN, TX, 78720, US

(21) Appl. No.: 10/460,494

(22) Filed: Jun. 12, 2003

(51) Int. Cl. G06F 15/00

(52) U.S. Cl. 358/1.15; 358/1.14; 358/1.1

(57) ABSTRACT

Printers interfaced with a SOHO network, such as a peer-to-peer network, are monitored from a client of the SOHO network with a printer administration tool of the client. A polling engine of the printer administration tool periodically polls the network to find the printers and retrieve each printer's status. An error detection engine of the printer administration tool determines if a printer has an error status, such as a paper jam status or low consumable status, such as low ink, toner or paper. A printer administration graphical user interface generates a table to display the found printers and each found printer's status and also displays notice of found printers having an error status. For instance, the printer administration graphical user interface displays each found printer as an icon within the generated table to allow a user to selectively interact with the printers and indicates determined errors with a color code or a separate notice pop-up window.

### BACKGROUND OF THE INVENTION

1. Field of the Invention

The present invention relates in general to the field of monitoring network operations, and more particularly to a method and system for monitoring status of printers from a SOHO network client.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems advance in processing and communication capabilities, a greater number of homes and small businesses are taking advantage of Small Office Home Office (“SOHO”) networking capability. Typical SOHO networks communicate over local area network (LAN) or wireless area network (WAN) communication media using peer-to-peer network configurations supported by the Windows operating system. Peer-to-peer network configurations establish communication between network information handling system clients without the use of a server information handling system. In a SOHO peer-to-peer network, client information handling systems access functionality of other client information handling systems though a LAN, such as storing and retrieving data and using peripheral devices like printers. Thus, several information handling system clients of a SOHO peer-to-peer network may use a single printer that communicates with the LAN, such as with a network interface card or through a client of the network.

An important advantage to the use of peer-to-peer networks is that, by avoiding the use of a centralized server information handling system, peer-to-peer networks operate with substantially less expense and complexity than server-based networks. However, the use of a peer-to-peer configuration also reduces the availability of centralized network management tools and techniques that are typically accomplished through network servers. For example, larger server-based networks often use common printing devices that are managed by a dedicated server information handling system or a control module located on a data server information handling system. Examples of such server-based printer management solutions are JetAmin and MarkVision, software packages available from HP which run on print servers to support enterprise network configurations. Although these programs manage and monitor printers on server-based networks to check if printers are on-line or in an error condition, server-based solutions are generally not applicable on peer-to-peer network configurations. Instead, to monitor printers a peer-to-peer network administrator generally must log onto printers directly from a client information handling system with a status tool or through a browser that reads a printer HTML status web page stored in printer firmware. Active monitoring of a SOHO network with plural printers tends to become burdensome in that separate status windows generally are opened for each printer device that an administrator desires to monitor.

### SUMMARY OF THE INVENTION

Therefore a need has arisen for a method and system which monitors printers of a SOHO network through a client information handling system.

In accordance with the present invention, a method and system are provided which substantially reduce the disadvantages and problems associated with previous methods and systems for monitoring printers of a SOHO network. A printer administration tool operating on a client information handling system of the SOHO network finds printers interfaced with the SOHO network and retrieves status information for the found printers for display at the client information handling system so that a single application on a client information handling system provides effective monitoring of plural SOHO networked printers.

More specifically, a peer-to-peer SOHO network interfaces plural printers through printer network interface cards or client information handling systems that support the printers as peripheral devices. A printer administration tool operating on a client information handling system has a polling engine that finds the printers interfaced with the network and retrieves their status information. An error detection engine of the printer administration tool determines any printers that are in an error state, such as low toner or paper jam error states. A printer administration graphical user interface displays the found printers and status information in a printer status table with the printer identifications displayed as active icons that a user may select to directly contact the printer associated with the icon. In one embodiment, color or other indicators are used to identify printers in the table having an error state. In another embodiment, the printer administration tool periodically polls the network printers to identify error states and a pop-up window is displayed at the client information handling system when an error state is determined.

The present invention provides a number of important technical advantages. One example of an important technical advantage is that plural printers of a SOHO network are found and the status of the printers determined through a single application operating on a client information handling system. Periodic polling from the client information handling system printer administration tool monitors printer states and provides notice of error states in an automated fashion. Thus, the printer administration tool provides effective client-based printer monitoring and management for peer-to-peer networks or other networks that lack a centralized printer server.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for monitoring SOHO network printers with a client information handling system; and

FIG. 2 depicts a flow diagram of a process for monitoring SOHO network printers with a client information handling system.

### DETAILED DESCRIPTION

Printers interfaced with SOHO networks are monitored from a network information handling system client that polls the network to find printers and displays found printers along with status at the client information handling system. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

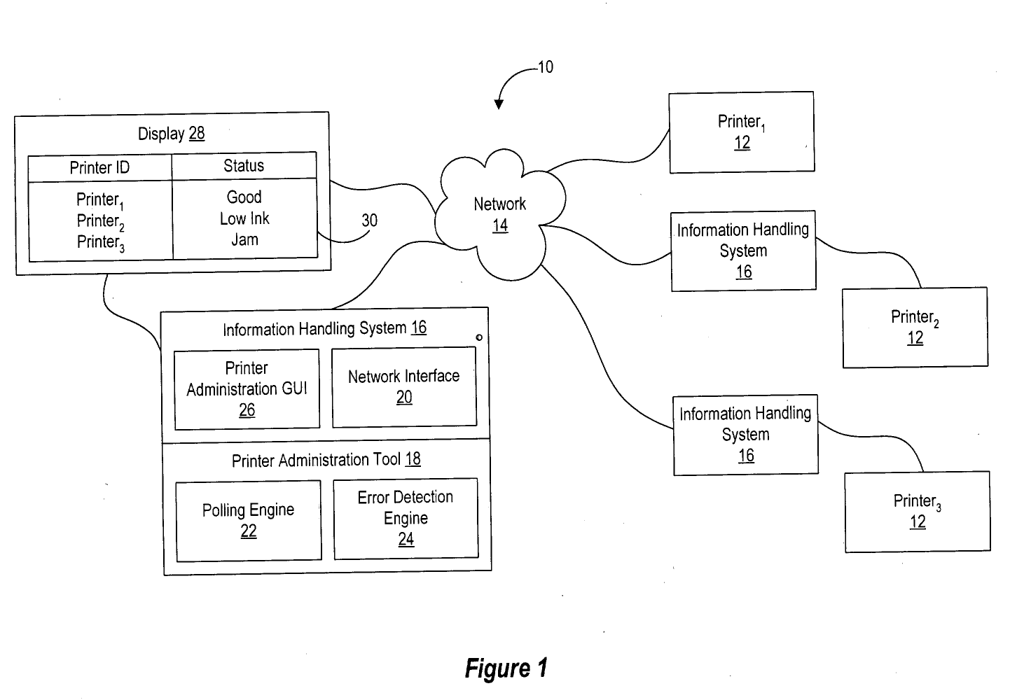

Referring now to FIG. 1, a block diagram depicts a SOHO network, client-based printer monitoring system 10 that monitors the status of printers 12 across a SOHO network 14. SOHO network 14 is a peer-to-peer network having plural client information handling systems 16 that communicate to perform network functions without a defined information handling system server. Printer, 12 is an independent printer equipped with a network interface accessible by the client information handling systems 16. Printer₂ and printer₃ operate as peripherals to information handling systems 16 and are accessible to other information handling system clients by communicating with their respective host information handling systems. For instance, a client information handling system 16 may command a print through network 14 directly to printer1 through printer1's network interface, or may command a print through network 14 to peripheral printer₂ or printer₃ by communicating with the host of printer₂ or printer₃. Printers 12 maintain status information that is accessible to client information handling systems 16 through network 14, such as status information maintained as an HTML web page in printer firmware or with proprietary status tools that are typically accessed with a printer driver of the client information handling system.

To provide monitoring of printer status in a SOHO network, a printer administration tool 18 operating on a client information handling system 12 polls through network interface 20 to find and retrieve status information from printers 12. For instance, a polling engine 22 of printer administration tool 18 periodically pings the network for printer devices and, for each printer device that responds, obtains status information, such as through the printer's HTML status page or through a driver interface. An error detection engine 24 of printer administration tool 18 analyzes the status information to detect any error status, such as a low consumable status, such as low ink, toner or paper, or paper jam status. The retrieved printer and printer status information and error status determinations are provided to a printer administration graphical user interface 26, which formulates the printer and status information for presentation at a display 28 of client information handling system 16. In one embodiment, a table display lists a column with the found printer identifications and an associated column with the status of each found printer. The printer identifications are displayed as icons which as user may activate to access the identified printer, with the status of each printer indicated by icon color, such as red for error and green for normal. In an alternative embodiment, printer administration graphical user interface 26 displays pop-up windows if an error status is determined.

Printer administration tool 18 aids active administration of SOHO network printer devices by displaying printer status information at a client information handling system and by automatically polling printer status periodically to detect and display errors. For instance, an administrator has a notice displayed at detection of desired trigger events, such as a predetermined printer consumable level (ink, toner or paper level) or paper jam, to allow timely response by the administrator to the issue associated with the trigger event. Further, printer administration tool 18 may automatically interact with other client information handling systems to communicate through network 14 and display desired printer status at other client information handling systems, such as with an e-mail notice of a low consumable, such as ink, toner or paper, or an FTP of the printer status table 30 to another information handling system.

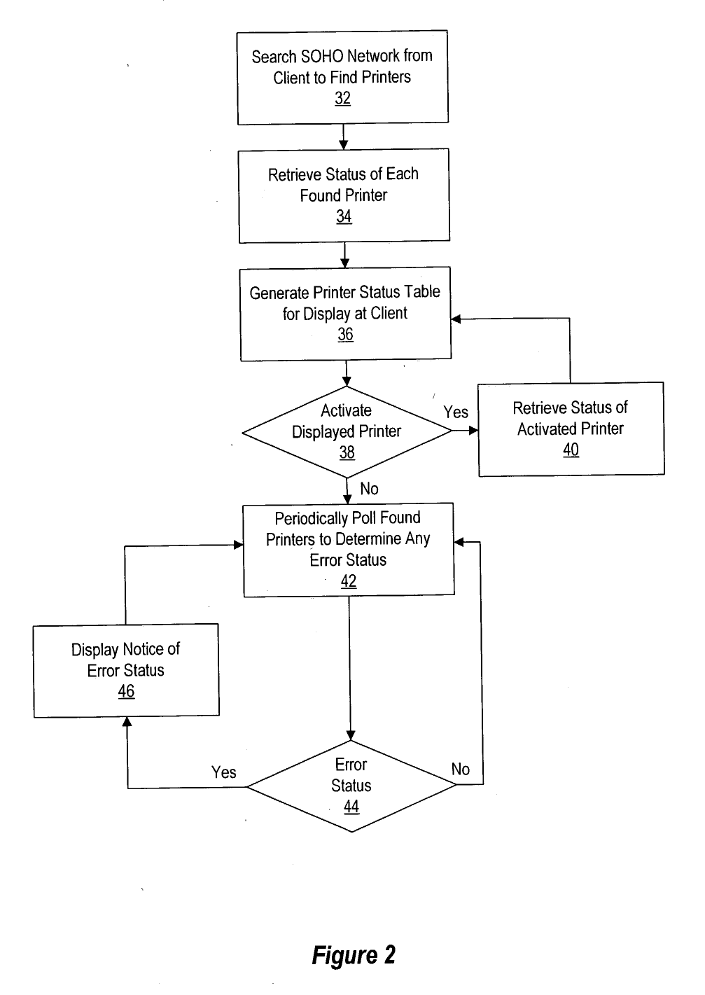

Referring now to FIG. 2, a flow diagram depicts a process for monitoring printers of a SOHO network from a client information handling system. At step 32, a printer administration tool of the client information handling system searches the network to find all printers associated with the network. At step 34, the status information of each found printer is retrieved by the printer administration tool and a determination made of any printers having an error status. At step 36, a printer status table is generated for display at the client information handling system with any determined error status highlighted, such as with a colored display. At step 38 a determination is made of whether a displayed printer is activated, such as with selection by a mouse of a found printer identification icon. If a displayed printer is activated, the process continues to step 40 for retrieval and display of status information from the activated printer and then returns to step 36. If a displayed printer is not activated, such as within a defined time period, the process continues to step 42 at with the printer administration tool periodically polls the found printers to determine any error status that arises with a found printer. If at step 44 no error status is determined, the process returns to step 42 for periodic polling at desired time intervals. If at step 44 an error status is determined, the process continues to step 46 for display of notice of the error status and then returns to step 42 for periodic polling of found printers at desired time intervals.

Although the present invention has been described in detail, it should be understood that various changes, substitutions and alterations can be made hereto without departing from the spirit and scope of the invention as defined by the appended claims.

What is claimed is:

1. An information handling system comprising:
processing components operable to process information;
a network interface operable to communicate information with a network as a client, the network having plural printers, the printers having status information; and
a printer administration tool operating on the processing components and communicating with the network through the network interface, the printer administration tool operable to find the printers interfaced with the network and retrieve the status of the printers for display at the information handling system.

2. The information handling system of claim 1 further comprising a printer administration graphical user interface operable to display a printer status table, the printer status table depicting the status information of each found printer.

3. The information handling system of claim 2 wherein the status information comprises an HTML page stored in printer firmware.

4. The information handling system of claim 2 wherein the printer administration tool is further operable to periodically retrieve the status of found printers and the printer administration graphical user interface is further operable to display each error status retrieved.

5. The information handling system of claim 4 wherein the error status comprises a paper jam.

6. The information handling system of claim 4 wherein the error status comprises a low consumable level.

7. The information handling system of claim 2 wherein activation of a displayed printer from the table initiates communication with the printer to retrieve the status of the printer.

8. The information handling system of claim 1 wherein the network comprises a peer-to-peer network.

9. The information handling system of claim 1 wherein the network comprises a SOHO network.

10. A method for monitoring the status of plural printers interfaced with a network from a client of the network, the method comprising:
searching the network from the client for printers interfaced with the network;
retrieving the status from each found printer to the client; and
displaying at the client a table having each found printer and the status retrieved for each found printer.

11. The method of claim 10 wherein searching the network further comprises searching a SOHO network.

12. The method of claim 10 wherein searching the network further comprises searching a peer-to-peer network.

13. The method of claim 10 wherein searching the network further comprises:
periodically polling the found printers to retrieve each found printers' status;
determining that one or more of the found printers has an error status; and
displaying at the client a notice of the determined error status.

14. The method of claim 13 wherein the error status comprises a paper jam status.

15. The method of claim 13 wherein the error status comprises an ink low status.

16. The method of claim 13 wherein displaying at the client a notice of the determined error status further comprises displaying in red at the table the found printers having an error status and displaying in green at the table the found printers lacking an error status.

17. The method of claim 13 wherein displaying at the client a notice of the determined error status further comprises displaying a window that identifies the printer having an error status.

18. A printer administration tool for monitoring plural printers of a SOHO network from a client of the SOHO network, the printer administration tool comprising:
a polling engine interfaced with the network and operable to find printers interfaced with the network and to retrieve the status of each found printer;
an error detection engine operable to determine found printers having an error status;
a printer administration graphical user interface operable to generate a table for display of the found printers and associated status as determined by the polling engine and to display a notice of an error status determined by the error detection engine.

19. The printer administration tool of claim 18 wherein the SOHO network comprises a peer-to-peer network.

20. The printer administration tool of claim 19 wherein the polling engine is further operable to periodically poll the found printers to obtain current printer status.
